(19) United States
(12) Patent Application Publication
(10) Pub. No.: US 2016/0344567 A1
(43) Pub. Date: Nov. 24, 2016

(54) MULTI-CHANNEL CONFERENCING

(71) Applicant: Avaya Inc., Santa Clara, CA (US)

(72) Inventors: Amol Navale, Pune (IN); Sameer Gengane, Pune (IN); Sudhir Nivrutti Shelke, Pune (IN)

(21) Appl. No.: 14/719,494

(22) Filed: May 22, 2015

(51) Int. Cl. H04L 12/18; H04L 29/06

(52) U.S. Cl. CPC H04L 12/1822; H04L 65/4038

(57) ABSTRACT

Conferencing systems allow a number of participants to electronically communicate with a number of other participants. Conferencing systems, especially when facilitating a conference with a large number of participants, become very burdensome to manage. As provided by certain embodiments described herein, endpoint data channels (e.g., audio, video, data, etc.) may be selectively enabled or disabled during a conference, as well as, the connecting of certain endpoints to enable sidebar conversations, based upon a group operation. The group is statically or dynamically determined by commonality of a participant attribute. A group-based conferencing operation then allows for simultaneous actions to be performed on the subset of conference participants without one-by-one operations.

### FIELD OF THE DISCLOSURE

The present disclosure is generally directed toward electronic conferencing systems and more specifically to electronic conferencing systems having multiple communication channels.

### BACKGROUND

Conferences, more specifically, electronic conferences utilizing a network and endpoints to communicate with each other and/or a host, are a popular alternative to in-person meetings and the logistical issues large gatherings present. A user, such as a moderator, host, or current presenter may perform actions, such as dropping certain participants, muting their audio, etc. Additionally, a set of participants may utilize a “whisper conference” to have sidebar conversations that exclude other participants. However, despite the current state of the art in conferencing technology, issues remain.

Conferences may comprise multiple levels (roles) of users (participants) who are engaged in a conference call. However, one of the users may want to share certain information with only a certain subset of the participants. In such a situation, the user has two options: first, the user may select each participant individually to receive the information. Once selected, the user may then speak, using a single line conference (whisper), to the selected subset of participants. Second, the host or moderator may select participants one-by-one, who are not receiving the information, to be dropped or have their audio feed suspended. Then, if the conference is to resume, the participants are individually added back to the conference.

Conferences may include individuals from different departments, groups, or levels in an organization. An action, such as presenting information to only managers and not to non-manager participants may require the dropping of each participant not authorized to continue the conference. Alternatively, each authorized participant may drop from the conference to conduct their own separate conference. Unfortunately, a host or the individuals then need to re-add each participant back into the main conference. This may require utilizing email or instant messaging to inform dropped participants to rejoin the conference.

Electronic conferences' networking endpoints, and their associated participants, (more simply, “conferences”) are presently burdensome to manage. As a result, certain functionality that is often beneficial to a conference cannot be executed quickly enough by a human operator. Therefore, a problem exists and could be mitigated if the host were given features and options to perform certain actions on participants based on requirements.

Embodiments described herein provide a rich experience to the host, for performing certain conferencing actions on a plurality of conference participants with a single click, and for the participants to participate to the degree appropriate. A set of participants is retrieved and segregated based on requirements, such as from a directory (e.g., LDAP, MDP, Exchange, organizational chart, etc.).

In one embodiment, a request is received from a host, or host-participant, to identify participants based on a specific requirement. For example, the host can request to sort the participants based on workgroups, departments, role, skill, etc. In a conference, such as a patent committee conference, there are many people who attend the conference. Examples of such participants include, business heads, technical panelists, in-house counsel, outside counsel, inventors, presenters, and others. Based on the host's request, the participants are segregated by an attribute, such as by the aforementioned groups.

Thereafter, a listing of the attributes may be presented to a host. Only as an option would the individuals associated with the specific attribute need to be displayed. The host may then select an attribute and trigger a conferencing action based on the selection. For example, if the host were an attorney who wished to have a sidebar conversation with other attorneys participating in the conference. Accordingly, the host may select a group (e.g., “Legal”) as an attribute and an action (e.g., “sidebar conversation”). In another example, certain participants may be disconnected from an audio channel, such as when a large group of participants wish to temporarily exclude a small number of participants.

In one example, a host has two-hundred participant lines to select for muting, which may take several minutes to perform. After the topic has been discussed, the action then has to be repeated to re-enable those participants. This is a burdensome activity that may cause participants to become frustrated or to circumvent or ignore confidentiality policies. As a benefit of the embodiments herein, participants may be included or excluded from one or more channels of a conference by a conference action applied simultaneously to a group having a common attribute. It should be appreciated that actions are considered simultaneous when performed at the speed of a computer or computer system, which may occur at different times, wherein the time differential is trivial and caused solely by physical limitations of the speed of electricity through a processor or conductor and/or accessing a value stored in a magnetic, electrical, and/or optical data storage device and without waiting for a human operator to perform an action.

In another embodiment, a corporate organizational chart provides a hierarchy of participants. For example, a conference may comprise: higher-level/superior roles (e.g., User-B (Manager), User-C (Director), User-D (VP)), which may be included in audio-video channels and lower-level subordinate employees (e.g., User-X, User-Y, User-Z), which may be permitted to participate via an audio-only channel.

In one embodiment, User-A initiates a conference, which is joined by User-B, User-C, User-D, User-X, User-Y, and User-Z. During the conference, a user wishes to discuss a topic not intended for all participants (e.g., User-A wants to discuss moving a number of subordinates from one project to another, but such a move should be considered confidential until executed). User-A then selects “mute” and “subordinates” whereby the subordinate employees (e.g., User-X, User-Y, and User-Z) have their lines muted. By selecting a conference action, which may be performed via speech command (e.g., “Block audio for subordinates”), User-A may then block the audio and/or video for that subordinate group and continue the conversation with the superior group.

In another embodiment, User-A initiates a conference. User-B, User-C, User-D, User-X, User-Y, and User-Z join the conference. During the conference, User-A wishes to start a collaboration session with a particular set of groups during the conference call (e.g., a sidebar conversation). For example, User-A wishes to share confidential information with only the higher-level participants of the conference and not the lower-level participants. As such, User-A may select the higher-level participants via a computer input, which may include a spoken command (e.g., “Start a collaboration session with superiors.”). The “superior” group is then interconnected via a channel exclusive of the “subordinate” group whereby they may conduct a sidebar conversation in audio, video, text, data, or other media.

In another embodiment, User-A initiates a conference. User-B, User-C, User-D, User-X, User-Y, and User-Z join the conference. During the conference, User-A wishes to share some confidential details with only the superiors and not with the subordinates. User-A may then drop the subordinates via input, such as via speech recognition, and continue the conference call with only the directors and managers of the “superior” group.

In another embodiment, User-A initiates a conference. User-B, User-C, User-D, User-X, User-Y, and User-Z join the conference. During the conference, User-A wishes to give a training session to subordinates only. User-A may drop the superiors via audio recognition or the link method & continue the conference call with the subordinates. However, a hierarchical list of authorities, such as from a LDAP may provide permissions granted to “subordinates” to “superiors” as well. For example, a user selects or issues a speech command (e.g., “Let's drop superior”). The superior group is dropped and the training of the subordinates may then proceed. Users associated with the superior group may be included via inheritance into the subordinate group.

In another embodiment, User-A initiates a conference. User-B, User-C, User-D, User-X, User-Y, and User-Z join the conference. During the conference, User-A wishes to mute only subordinates in the conference call. User-A then selects or issues an audio command detected by a speech recognition component thereby muting the subordinates' lines. Similarly, the command to mute another group (e.g., “superior”) may be issued to mute the audio signal to the endpoints associated with the other group.

In one embodiment, an electronic conferencing system is disclosed, comprising: a server enabling a connection between a plurality of endpoints thereby allowing the plurality of endpoints to engage in a conference; a database having records stored therein associating each participant of the conference with a participant attribute; an interface configured to receive an input during the conference associated with a first attribute value; the server being further configured to select at least one participant having a participant attribute that is substantially equivalent to the first attribute value; the interface being further configured to receive the input further comprising a conferencing action; and the server being further configured to simultaneously perform the conference action, in response to the input, on the at least one participant having the participant attribute that is substantially equivalent to the first attribute value and omitting the conference action from participants having the participant attribute that is not substantially equivalent to the first attribute value.

In another embodiment, a method is disclosed, comprising: connecting a plurality of endpoints thereby allowing the plurality of endpoints to engage in a conference; receiving an input during the conference associated with a first attribute value and a conference action; selecting at least one participant having a participant attribute that is substantially equivalent to the first attribute value; and in response to the input, simultaneously performing the conference action on the at least one participant having the participant attribute that is substantially equivalent to the first attribute value and omitting the conference action from participants having the participant attribute that is not substantially equivalent to the first attribute value.

In another embodiment, a non-transitory computer-readable medium is disclosed with one or more instructions thereon that when read by a computer cause the computer to perform: connecting a plurality of endpoints thereby allowing the plurality of endpoints to engage in a conference; receiving an input during the conference associated with a first attribute value and a conference action; selecting at least one participant having a participant attribute that is substantially equivalent to the first attribute value; and in response to the input, simultaneously performing the conference action on the at least one participant having the participant attribute that is substantially equivalent to the first attribute value and omitting the conference action from participants having the participant attribute that is not substantially equivalent to the first attribute value.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

It should be noted that, unless expressly stated otherwise, operations are performed on a channel provided to or received from an endpoint and not an operation on the endpoint itself whereby an endpoint is made to not capture an input or not present a received signal for output. For example, as used herein, an operation such as “mute” refers to the termination of an audio channel to a target endpoint or endpoints by a presentation server or other channel manager to cause the target endpoint to not receive an audio signal. While a user may select mute on their respective endpoint to silence their endpoint's audio signal, unless otherwise noted, channel activation and deactivation performed solely at the endpoint are distinct operations from the embodiments disclosed herein. Similarly, unless otherwise noted, silencing an endpoint with respect to any channel (e.g., audio, video, data, etc.) is performed as a channel management operation by a server, conference manager, or other host-controlled component and not as an endpoint operation.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a user interface in accordance with embodiments of the present disclosure;

FIG. 4 depicts directory records and the processing thereof in accordance with embodiments of the present disclosure;

FIG. 5 depicts a first process in accordance with embodiments of the present disclosure; and

FIG. 6 depicts a second process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

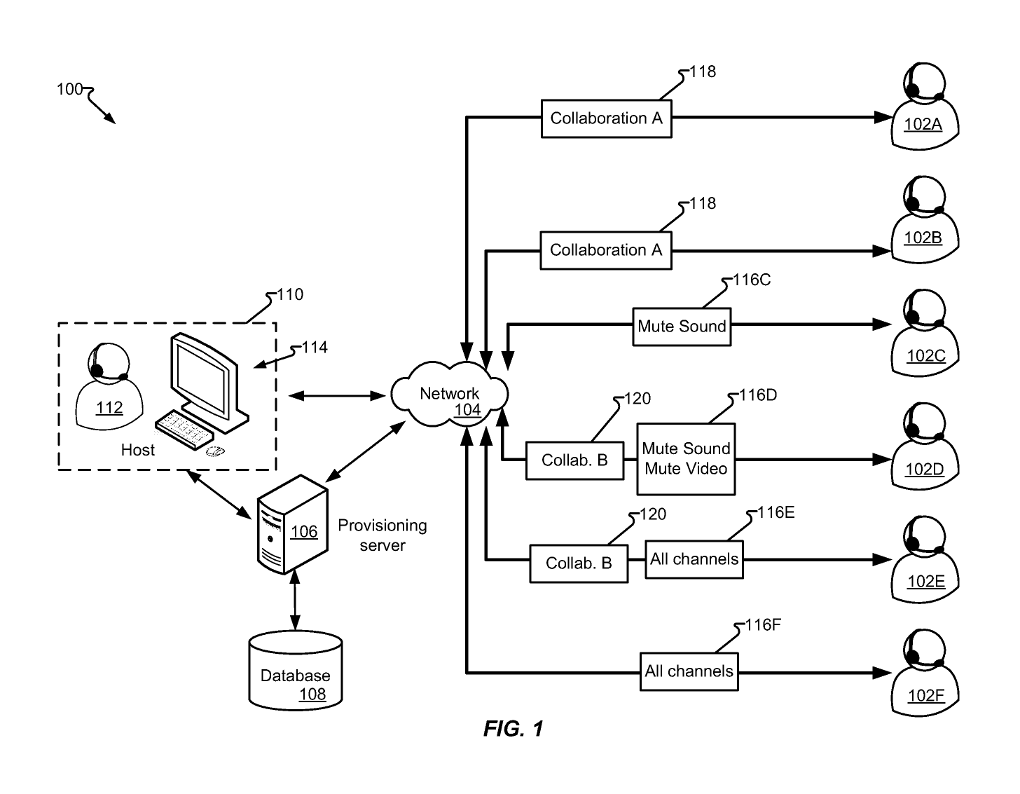

FIG. 1 depicts system 100 in accordance with embodiments of the present disclosure. In one embodiment, network 104 connects participants 102 to enable a conference therebetween. It should be appreciated that participants 102 each utilize an electronic device or devices (e.g., computer, smart phone, laptop, tablet, etc.) for connectivity to network 104 and the providing of signals to and from network 104, such as those associated with participation in the conference. The illustration of the endpoints is omitted to avoid unnecessarily complicating the figure.

The conference may be set up and managed by provisioning server 106. Provisioning server 106 may be a dedicated communication server or component thereof. In another embodiment provisioning server 106 may represent an endpoint device associated with one of participants 102. Provisioning server 106 facilitates the interconnection of participants 102 in the management of specific communication channels between two or more participants 102. Provisioning server 106 may receive setup instructions from host system 110, which may comprise post terminal 114 operated by host 112. In another embodiment, host 112 is one of participants 102. Host system 110 may provide for in-conference alterations to the connectivity between two or more participants 102.

Provisioning server 106 may access database 108 such as to retrieve participants, which may further be selected by host 112 utilizing host terminal 114. Database 108 may also provide attributes associated with participants 102, which may then be utilized for group conferencing actions provided by provisioning server 106 during in-conference alterations of the connectivity between the two or more participants 102. In another embodiment, provisioning server 106, database 108, and/or host system 110 may comprise a participant of the conference, for example participant 102F.

In one embodiment, each of participants 102 are interconnected and presently engaged in a conference. The conference comprising at least one of audio, video, text, shared files, co-browsing, application output, etc. each provided on a communication channel managed by provisioning server 108 via delivery through connectivity to network 104. Initially, each participant 102 may be enabled to utilize all channels associated with the conference.

In another embodiment, during the conference, a need arises whereby dissimilar communication between at least two participants 102 is desired. The dissimilarity may comprise exclusion from a portion of the data channels, exclusion from all data channels, and/or inclusion in a sidebar conversation utilizing at least one data channel. In a further embodiment, participants 102 are segregated based upon an attribute associated therewith. The attribute may comprise a position, role, title, department, or other attribute as may be determined as a matter of design choice and/or implementation need. For example, participants 102C and 102D each share a common attribute; however, other attributes or attribute values may not be common between participants 102C and 102D. Additionally, participants 102A, 102B, 102E, and 102F may each comprise at least one common attribute value. It should be appreciated that an attribute value may be different between at least two participants 102 when at least one participant 102 does not have the particular attribute. For example, participant 102D may be a contractor and not have a “department” attribute associated with participants 102 who are employees. Alternatively, participant 102D may have a “department” attribute comprising a null value or otherwise indicate the absence of a value.

In another embodiment, the conference is proceeding to topics for which certain participants 102 are to be excluded. Host 112 may then select “non-employees” and/or contractors to cause the video channel to be suspended for participants 102 who are not “employees.” As a result, the video feed provided to an endpoint of participant 102D, and any other contractors or non-employees, is suspended. In a further embodiment, the conference proceeds to another topic further requiring the exclusion of participants 102 having a different attribute and/or not having a particular attribute. For example, audio feed provided to the endpoint associated with participants 102C and 102D may be suspended. Channel settings 116 C illustrate the muting of the audio provided to participant 102C and channel settings 116 D illustrate the muting of audio and video provided to the endpoint associated with participant 102D.

In another embodiment, a group of participants 102 desires to have a sidebar conversation. Participants 102A and 102B each share a common attribute and wish to discuss something outside of the main conference. Host 112 then selects a sidebar initiation option on host terminal 114 thereby connecting participant 102A and 102B on a separate data channel to the exclusion of other participants 102C-102F. Similarly, another sidebar may be established between a participant sharing a different group attribute, such as participants 102D and 102E. Utilizing terminal 114, host 112 may then connect participant 102D with participant 102E by selecting an option to initiate a sidebar associated with the participants having the second group attribute. As a result, sidebar 120 is initiated between participants 102D and 102E and sidebar 118 is initiated between participants 102A and 102B.

The establishment of first sidebar 118, second sidebar 120, and/or the implementation of channel settings 116C, 116D, 116E, 116F may be provided by host 112 providing inputs to host terminal 114. In another embodiment, one of participants 102 may provide the command input, whereby a speech recognition component may provide the instruction to provisioning server 106, which may then implement the modification to the conference.

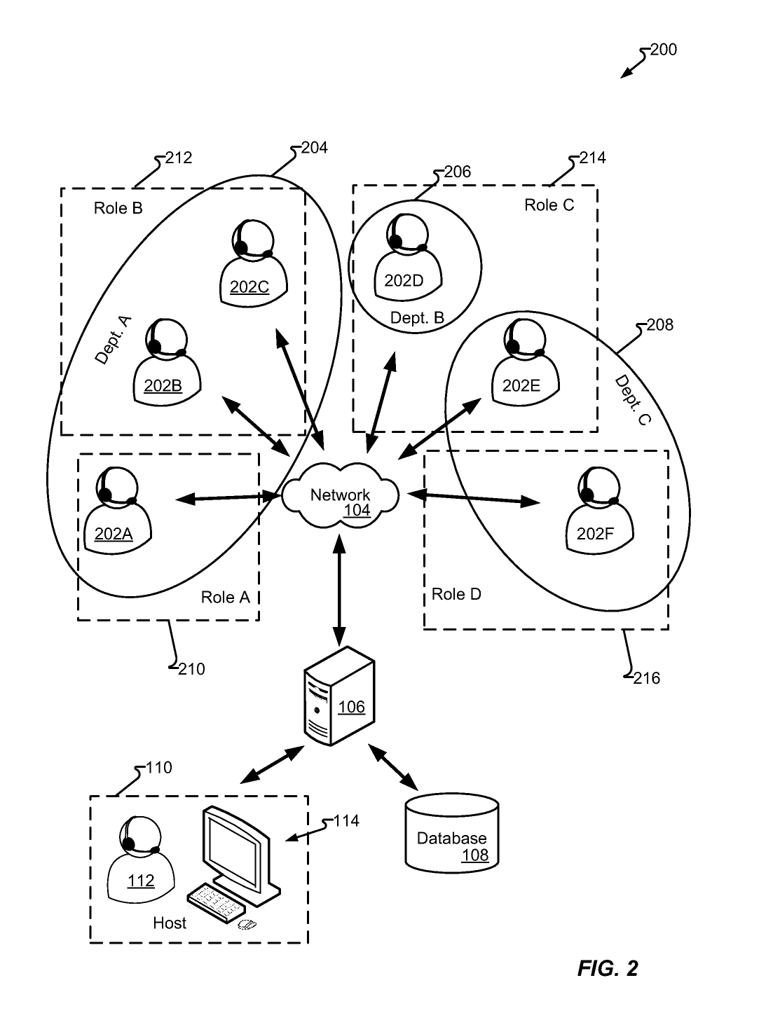

FIG. 2 depicts system 200 in accordance with embodiments of the present disclosure. In one embodiment, FIG. 2 illustrates attribute values associated with individual participants 202 and the groupings that may result therefrom. As a result of the groupings, host 112 utilizing host terminal 114 or one of participants 202 operating as a host may then initiate conferencing actions based upon the groups without management of individual participants 202.

In one embodiment, participants 202 are selected for a conference. Database 108 provides provisioning server 106 and host system 110 with records associated with ones of participants 202, such as attributes for which participants 202 may have in common or differ from at least one other participant 202. In one embodiment, database 108 comprises attributes associated with each participant 202 and a department and role for each participant 202. For example, participants 202A, 202B, and 202C each have department attribute 204 in common, such as “department A”. Participants 202E and 202F each have department attribute 208 in common, such as “department C”. And participant 202D may be alone in having department attribute 206, such as “department B.” In another embodiment, each of participants 202 comprises a role attribute, which may be a particular task, skill, position, title, or other attribute as may be relevant in a particular organization or for a particular project associated with the conference. In one embodiment, participant 202A is associated with role attribute 210 having a value of “role a,” participants 202B and 202C each have role attribute 212 comprising “role B,” participants 202D and 202E each have role attribute 214 comprising “role C,” and participant 202F comprises role attribute 216 having a value of “role D.”

As a benefit, host 112 and/or one of participants 202 may perform a conferencing action, such as the muting of an audio feed, video feed, data feed, application output feed, or other channel blocking or resumption. For example, participant 202A may wish to have a sidebar conversation with participants having department attribute 204 comprising the value of “department A” and may speak a command, such as “initiate sidebar conversation with department A,” whereby a sidebar channel comprising two-way audio is established between participants 202A, 202B, 202C to the exclusion of other participants. Other actions may similarly be spoken, such as to terminate the sidebar conversation associated with department attribute 204 or to otherwise block or resume a particular data channel for individuals having or not having, as the case may be, one of a particular role or department attribute (e.g., role attributes 210, 212, 214, 216 and/or department attributes 204, 206, 208).

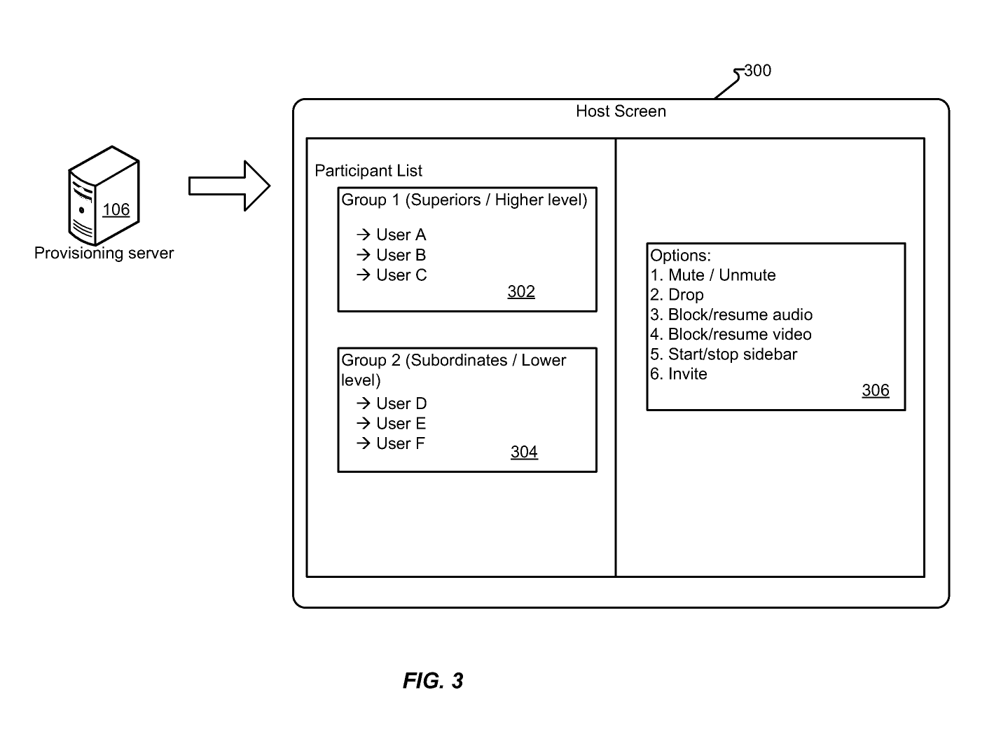

FIG. 3 depicts user interface 300 in accordance with embodiments of the present disclosure. In one embodiment, interface 300 is a portion of a display, such as on host terminal 114. In another embodiment, an endpoint associated with one participant (e.g., one of participants 102, 202) may be configured to display, at least selectively attributes of a particular one or more participants (e.g., name, extension, etc.) as may be determined by a host, moderator, and/or another one of participants 102, 202. Interface 300 may receive status information from provisioning server 108, which may comprise data from database 108 to indicate available operations, status of conference channels, and/or status of participants having a particular attribute.

In one embodiment, interface 300 displays participant list in group 1 (302) and group 2 (304). The specific segregation provided in the participant list, whereby groups 302 and 304 are defined, may be provided by automatic input, such as provisioning server 106 accessing database 108 (See FIGS. 1 and 2) having records associating participants with one or more participant attributes. Additionally, manual entry and/or selection of users to define one or more groups from a list of participants may also be provided. A combination of manual entry, automatic entry, and/or manual editing may also be provided.

Selection of a particular group, for example group 1 (302), may present an operator, such as host 112, with available options to perform on the selected group. For example, options menu 306 provides options to mute, unmute, drop, block and resume audio and video, start and stop sidebar conversations, and/or add additional participants.

As can be appreciated, other options, such as the ability to select a command from options menu 306 to perform on a target group (e.g., at least one of group 1 (302) and group 2 (304)), may be provided. As a further option, voice commands may be provided to allow participants and/or the host, such as host 112, to issue voice commands for the selection of a particular group, such as one of group 1 (302) or group 2 (304), and/or to perform the operations identified in menu 306. An authorized speaker of a command may also be a participant in the conference who may be granted certain attributes, such as manager, superior, etc. or may be a particular individual who may be a host or authorized by the host, such as host 112.

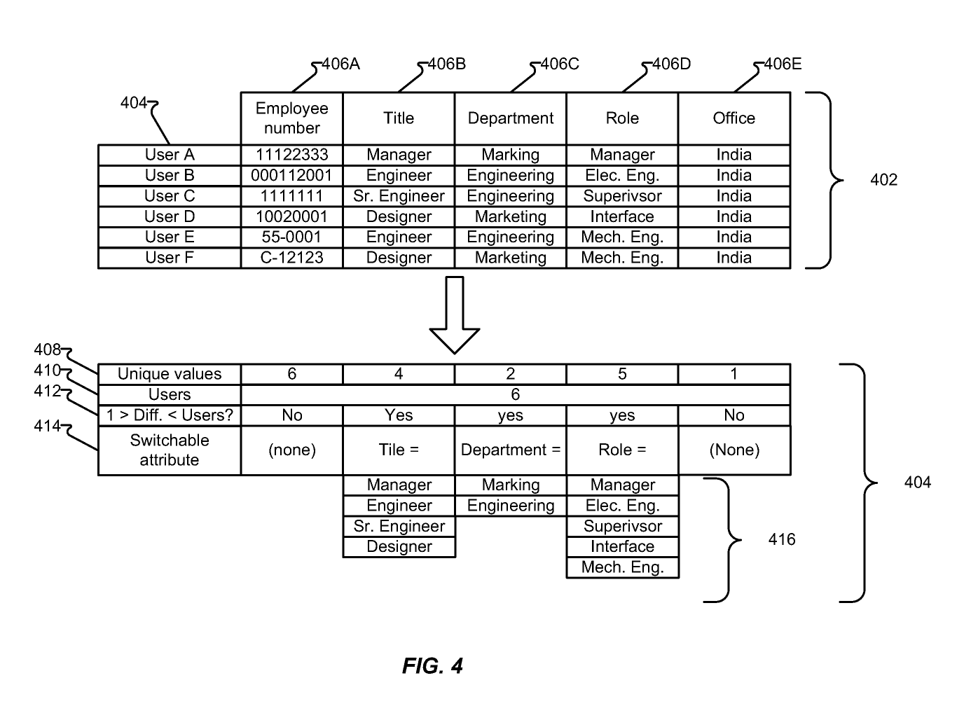

FIG. 4 depicts records 404 and the processing thereof in accordance with embodiments of the present disclosure. In one embodiment, directory database 402 comprises records that may be stored in a repository, such as database 108. A server or processor, such as provisioning server 106 and/or host terminal 114, and/or an authorized endpoint associated with the participant may be executed prior to a conference to determine attributes for which a group designation may be provided, such as group 1 (302,) or group 2 (304).

In one embodiment, participants 404 each have an attribute record comprising attributes 406, such as 406A (employee number), 406B (title), 406C (department), 406D (role), and/or 406E (office). Certain ones of attributes 406 are shared amongst all participants 404 and therefore provide no meaningful group designation. Additionally, certain records, such as employee number 406A, are unique to every participant 404, and similarly provide no meaningful participant attribute beyond an individual designation. As a result of a processing operation, process data 404 may then be created.

Process data 404 determines the number of unique values 408 for each attribute 406. User count 410 determines a number of participants associated with the pool of potential conference participants. Difference 412 determines if the number of unique values is between the entire pool of participants 404 or common to all users (participants 404). Accordingly, switchable attribute 414 is determined based upon an attribute detail 406 whereby the determination is made that the number of differences 412 is less than the number of all users and greater than one.

Switchable attribute 414 identifies attribute details 406 providing an ability to segregate participants 404 without making such a selection individual or applicable to the entirety of the participants for a prospective conference. The specific values are provided by attribute values 416 associated with switchable attributes 414. As a benefit, display screen 300 may derive a participant list comprising groups derived from attribute values 416 and/or switchable attributes 414.

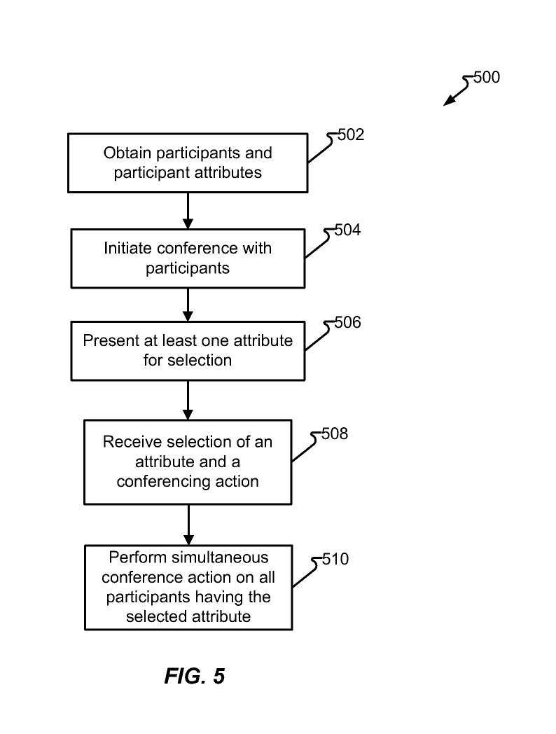

FIG. 5 depicts process 500 in accordance with embodiments of the present disclosure. In one embodiment, process 500 begins at step 502 where conference participants and participant attributes are first obtained. For example, provisioning server 106 may access database 108 to obtain a list of participants, which may further be defined by host 112 and/or a participant designated as a host. The participant attributes may similarly be accessed from a source, such as database 108 or dynamically created, such as by differences in participant attributes 406 (see FIG. 4).

Next, step 504 initiates the conference with the participants. In one embodiment, all participants are initially engaged in the conference with all available data channels operational to all endpoints associated with all participants. In another embodiment, certain endpoints may not be initially engaged on all data channels. As may be appropriate, data channels, which are not presently actively engaged in conveying conference input and/or output to a particular participant, may be provided with a placeholder, such as music on hold, a visual indicator that the conference is in progress but the video feed has been suspended, and/or another indicator.

Next, step 506 presents at least one attribute for selection by the user, such as host 112 or other authorized participant. The attribute, such as obtained in step 502, allows a conference action to be performed based upon selection of an attribute and not by a personal identifier (e.g., name, employee number, etc.). Next, step 508 receives a user selection of an action of a conferencing action in the group identified by a participant attribute. Next, step 510 performs a simultaneous conference action in accordance with the selection of the group in operation provided in step 508.

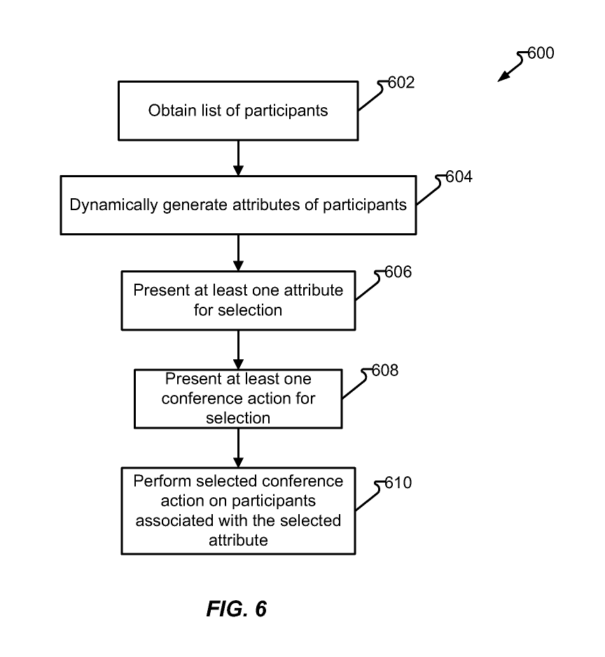

FIG. 6 depicts process 600 in accordance with embodiments of the present disclosure. In one embodiment, process 600 begins at step 602 obtaining a list of participants. The list of participants may be prospective or otherwise incomplete; however, in other embodiments, the list of participants is known with certainty. Next, step 604 dynamically generates a list of attributes, such as attributes 406, for the participant, such as participants 404.

Next, step 606 presents at least one attribute for selection by the user, such as host 112 or an authorized participant, such as one of participants 102, 202. Next, step 608 presents at least one conference action for selection, such as by a display receiving an input on display 300, such as operating on host terminal 114 or an endpoint associated with an authorized participant 102, 202. In another embodiment, step 608 may be a display in static form or otherwise admitted entirely, such as when step 608 is embodied as receiving a spoken command by an authorized participant and/or host 112.

Next, step 610 performs a selected conference action on the participants selected. As a further embodiment, additional operations may be performed, such as to provide help to ensure security of the operations. For example, step 602 may obtain a list of participants including an associated endpoint address (e.g., uniform resource indicator, telephone number, etc.). It may be determined, such as by provisioning server 106, that the associated endpoint address is located in a location having access by multiple parties, such as a conference phone or a telephone operating in speakerphone mode. In such embodiments, two or more participants may be associated with a single endpoint. The rights associated with the sharing participants may be dissimilar, in which case a worst-case scenario may be assumed in order to preserve security. For example, FIG. 2 depicts participant 202D and participant 202E each having a common role attribute 214 (role C) but dissimilar departments, having department attribute 208 (department C) and department attribute 206 (department B). However, participants 202D and 202E may be sharing an endpoint in operation whereby the muting of a line for one of participants 202D and 202E, but not the other, may be applied regardless of one of participants 202D and 202E having the rights to maintain the audio channel. As a further embodiment, the authorized participant may enter a code or otherwise grant access, such as when the authorized participant has the unauthorized participant leave the conference room being shared to participate in the conference.

In the foregoing description, for the purposes of illustration, methods were described in a particular order. It should be appreciated that in alternate embodiments the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions, to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An electronic conferencing system, comprising:
a server enabling a connection between a plurality of endpoints thereby allowing the plurality of endpoints to engage in a conference;
a database having records stored therein associating each participant of the conference with a participant attribute;
an interface configured to receive an input during the conference associated with a first attribute value;
the server being further configured to select at least one participant having a participant attribute that is substantially equivalent to the first attribute value;
the interface being further configured to receive the input further comprising a conferencing action; and
the server being further configured to simultaneously perform the conference action, in response to the input, on the at least one participant having the participant attribute that is substantially equivalent to the first attribute value and omitting the conference action from participants having the participant attribute that is not substantially equivalent to the first attribute value.

2. The system of claim 1, wherein the conference action comprises a sidebar conversation wherein ones of the first set of participants are communicatively connected to the exclusion of the participants that are not in the first set of participants.

3. The system of claim 2, wherein the sidebar conversation comprises at least one of text, voice, video, and a shared file.

4. The system of claim 1, wherein the participant attribute comprises a role attribute.

5. The system of claim 1, wherein:
the server further comprises a speech recognition function; and
wherein the input comprises a key phrase determined to be present in a portion of speech from at least one participant by the speech recognition function.

6. The system of claim 1, wherein the participant attribute comprises a lowest permission attribute of a plurality of participants associated with an endpoint operating in speakerphone mode.

7. The system of claim 6, wherein the participant attribute comprises a highest permission attribute of a plurality of participants associated with an endpoint operating in speakerphone mode upon receiving an authorization from the participant associated with the highest permission attribute.

8. The system of claim 1, wherein the participant attribute comprises a field from a participant directory.

9. The system of claim 1, wherein the server is further configured to automatically generate the participant attribute from the participant directory wherein the participant attribute is common to at least two participants and less than all participants.

10. The system of claim 1, wherein the conference action comprises at least one of suspending an audio channel, resuming an audio channel, suspending a video channel, resuming a video channel, suspending a text channel, resuming a text channel, suspending a presentation portion, and resuming a presentation portion.

11. A method, comprising:
connecting a plurality of endpoints thereby allowing the plurality of endpoints to engage in a conference;
receiving an input during the conference associated with a first attribute value and a conference action;
selecting at least one participant having a participant attribute that is substantially equivalent to the first attribute value; and
in response to the input, simultaneously performing the conference action on the at least one participant having the participant attribute that is substantially equivalent to the first attribute value and omitting the conference action from participants having the participant attribute that is not substantially equivalent to the first attribute value.

12. The method of claim 11, wherein the conference action comprises a sidebar conversation wherein at least two of the at least one participant having the participant attribute that is substantially equivalent to the first attribute value are communicatively connected to the exclusion of the participants that are not in the first set of participants.

13. The method of claim 11, wherein the participant attribute comprises a role attribute.

14. The method of claim 11, further comprising:
monitoring the conference with a speech recognition function; and
wherein the input comprises a key phrase determined to be present in a portion of speech from at least one participant by the speech recognition function.

15. The method of claim 11, wherein the participant attribute comprises a lowest permission attribute of a plurality of participants associated with an endpoint operating in speakerphone mode.

16. A non-transitory computer-readable medium with one or more instructions thereon that when read by a computer cause the computer to perform:
connecting a plurality of endpoints thereby allowing the plurality of endpoints to engage in a conference;
receiving an input during the conference associated with a first attribute value and a conference action;
selecting at least one participant having a participant attribute that is substantially equivalent to the first attribute value; and
in response to the input, simultaneously performing the conference action on the at least one participant having the participant attribute that is substantially equivalent to the first attribute value and omitting the conference action from participants having the participant attribute that is not substantially equivalent to the first attribute value.

17. The one or more instructions of claim 16, wherein the conference action comprises a sidebar conversation wherein at least two of the at least one participant having the participant attribute that is substantially equivalent to the first attribute value are communicatively connected to the exclusion of the participants that are not in the first set of participants.

18. The one or more instructions of claim 16, wherein the participant attribute comprises a field from a participant directory.

19. The one or more instructions of claim 16, further comprising instructions to automatically generate the participant attribute from the participant directory wherein the participant attribute is common to at least two participants and less than all participants.

20. The one or more instructions of claim 16, wherein the conference action comprises at least one of suspending an audio channel, resuming an audio channel, suspending a video channel, resuming a video channel, suspending a text channel, resuming a text channel, suspending a presentation portion, and resuming a presentation portion.
